(19) United States
(12) Patent Application Publication
(10) Pub. No.: US 2013/0318528 A1
(43) Pub. Date: Nov. 28, 2013

(54) INFORMATION PROCESSING METHOD

(71) Applicant: FUJITSU LIMITED, Kawasaki-shi (JP)

(72) Inventor: Motoyoshi HIROSE, Kawasaki (JP)

(73) Assignee: FUJITSU LIMITED, Kawasaki-shi (JP)

(21) Appl. No.: 13/864,722

(22) Filed: Apr. 17, 2013

(30) Foreign Application Priority Data
May 22, 2012 (JP) 2012-116846

(51) Int. Cl. G06F 9/455

(52) U.S. Cl. CPC G06F 9/455
USPC 718/1

(57) ABSTRACT

An information processing method executed by an information processing apparatus. The information processing includes: running a virtual machine that emulates an idle state of other information apparatus; powering on the other information apparatus when receiving a process execution request issued to the running virtual machine; and transferring the received execution request to the powered-on other information apparatus.

### CROSS-REFERENCE TO RELATED APPLICATION

This application is based upon and claims the benefit of priority from the prior Japanese Patent Application No. 2012-116846 filed on May 22, 2012, the entire contents of which are incorporated herein by reference.

### FIELD

The embodiments discussed herein are related to an information processing method.

### BACKGROUND

There have been known programs that run on a legacy operating system (OS) in a past system, such as a mainframe or office computer, or legacy inputs/outputs (IOs), such as a printer associated with a past system.

A program or legacy IO associated with a past system is called a legacy environment and used less frequently than a current system. There are some legacy environments that have difficulty in being replaced with current systems and therefore in being removed.

Further, legacy environments associated with a past system consume more power than a current system.

For example, a method of controlling the operation time of a legacy environment by operating the power supply manually or powering on the legacy environment for a limited period of time suffers an increase in operation cost or a reduction in service. Further, where a current system operates the power supply of a legacy environment, time and effort have to be taken to create middleware to be installed into the legacy environment or a script for the current system to control the legacy environment.

For example, there is also known a technology by which a current system achieves a legacy environment using a virtual machine technology. For example, there is known a technology that runs software developed for a legacy environment, such as a legacy OS, on a current central processing unit (CPU) using a virtual machine technology.

FIG. 27 is a diagram illustrating a traditional virtual machine. In an example illustrated in FIG. 27, a current system, host 50, includes an x86-family physical CPU 54, a physical memory 55, and a physical IO 56. The host 50 executes virtual machines 51 and 52 and a hypervisor 53 for controlling the virtual machines 51 and 52.

To run a legacy-environment guest OS, such as Unix or mainframe (MF), the virtual machine 52 includes a virtual CPU serving as an emulator for converting an instruction in the legacy environment, such as Unix or MF, into an x86 instruction.

However, in the technology of using a legacy environment in a current system while using a virtual machine, a program generated so as to run on a CPU in the legacy environment is run by a CPU in the current system. Multiple machine instructions in the legacy environment are converted into machine instructions in the current system and then executed. Accordingly, a virtual machine is difficult to develop.

Japanese Laid-open Patent Publication Nos. 2010-204962, 2011-100431, 10-011303, and 06-195315 are known as examples of the related art.

### SUMMARY

According to an aspect of the invention, an information processing method executed by an information processing apparatus. The information processing includes: running a virtual machine that emulates an idle state of other information apparatus; powering on the other information apparatus when receiving a process execution request issued to the running virtual machine; and transferring the received execution request to the powered-on other information apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an information system according to a first embodiment;

FIG. 2 is a diagram illustrating a hypervisor according to the first embodiment;

FIG. 3 is a diagram illustrating an example of an interrupt handling table;

FIG. 4 is a diagram illustrating the meanings of values stored in the state storage area;

FIG. 5 is a diagram illustrating an example of a virtual machine management table;

FIG. 6 is a diagram illustrating an example of a simplified virtual machine management table;

FIG. 7 is a diagram illustrating the meanings of values stored in an exceptional state register;

FIG. 8 is an example of an idle loop program according to the first embodiment;

FIGS. 9A and 9B are diagrams illustrating the state transition of a virtual machine;

FIG. 10 is a flowchart illustrating a process executed by a scheduler according to the first embodiment;

FIG. 11 is a flowchart illustrating a process executed by the scheduler according to the first embodiment;

FIG. 12 is a flowchart illustrating a process executed by an association function unit of the hypervisor according to the first embodiment;

FIG. 13 is a flowchart illustrating a process executed by a legacy information apparatus according to the first embodiment;

FIG. 14 is a sequence diagram illustrating a process that the information system according to the first embodiment executes to produce a printer output;

FIG. 15 is a diagram illustrating an information system according to a second embodiment;

FIG. 16 is a diagram illustrating a hypervisor according to the second embodiment;

FIG. 17 is a diagram illustrating an example of a virtual machine management table to the second embodiment;

FIG. 18 is a diagram illustrating the meanings of values stored in a state register;

FIG. 19 is a flowchart illustrating a process executed by a scheduler according to the second embodiment;

FIG. 20 is a first flowchart illustrating a process in which a virtual machine according to the second embodiment moves to a legacy environment;

FIG. 21 is a second flowchart illustrating the process in which the virtual machine according to the second embodiment moves to the legacy environment;

FIG. 22 is a flowchart illustrating a process executed by a legacy hypervisor according to the second embodiment;

FIG. 23 is a flowchart illustrating a process executed by a legacy virtual machine according to the second embodiment;

FIG. 24 is a first flowchart illustrating a process in which the virtual machine according to the second embodiment moves to a current system;

FIG. 25 is a second flowchart illustrating the process in which the virtual machine according to the second embodiment moves to the current system;

FIGS. 26A and 26B are sequence diagrams illustrating the flow of a process that the information system according to the second embodiment executes to produce a printer output; and

FIG. 27 is a diagram illustrating a traditional virtual machine.

### DESCRIPTION OF EMBODIMENTS

Now, an information apparatus, an information processing method, and a recording medium having an information processing program recorded thereon according to the present application will be described with reference to the accompanying drawings.

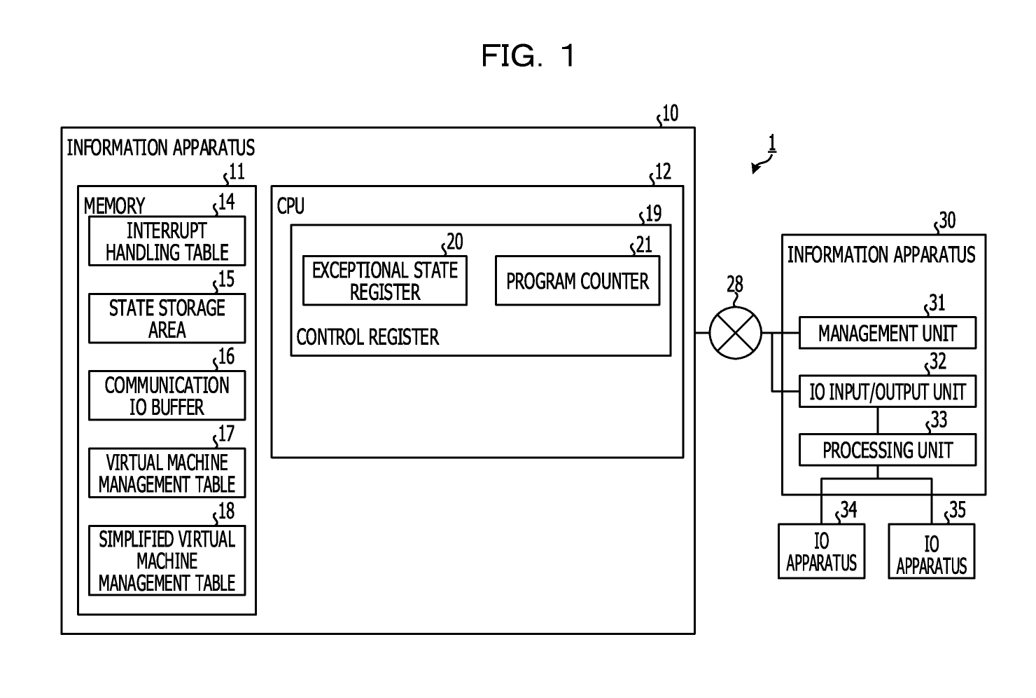

In a first embodiment below, an example of an information system including an information apparatus will be described with reference to FIG. 1. FIG. 1 is a diagram illustrating an information system according to the first embodiment. The information apparatus illustrated in FIG. 1 includes at least a central processing unit (CPU) and a memory and can run a virtual machine.

As illustrated in FIG. 1, an information system 1 includes an information apparatus 10, input/output (IO) apparatuses 28, 34, and 35, and an information apparatus 30. The information apparatus 10 is a current information apparatus and has a function of receiving a process execution request issued to the information apparatus 30, from other information apparatus (not illustrated) or client. The information apparatus 10 also has a function of controlling the power supply of the information apparatus 30 via the IO apparatus 28. The IO apparatus 28 communicates with a network interface card (NIC) or the like of the information apparatus 30.

The information apparatus 30 is a legacy information apparatus for running a past system, such as a mainframe or office computer. The IO apparatuses 34 and 35 are IO apparatuses associated with the legacy system, such as a printer or storage device.

The information apparatus 10 includes a memory 11 and a CPU 12. The memory 11 and the CPU 12 are coupled together via a communication line (not illustrated), such as a bus, so that they can communicate data to each other. The memory 11 stores an interrupt handling table 14, a state storage area 15, a communication IO buffer 16, a virtual machine management table 17, and a simplified-type virtual machine management table 18. The CPU 12 also includes a control register 19. The control register 19 includes an exceptional state register 20 and a program counter 21. The information apparatus 30 is coupled to the information apparatus 10 via the IO apparatus 28 and includes a management unit 31, an IO input/output unit 32, and a processing unit 33.

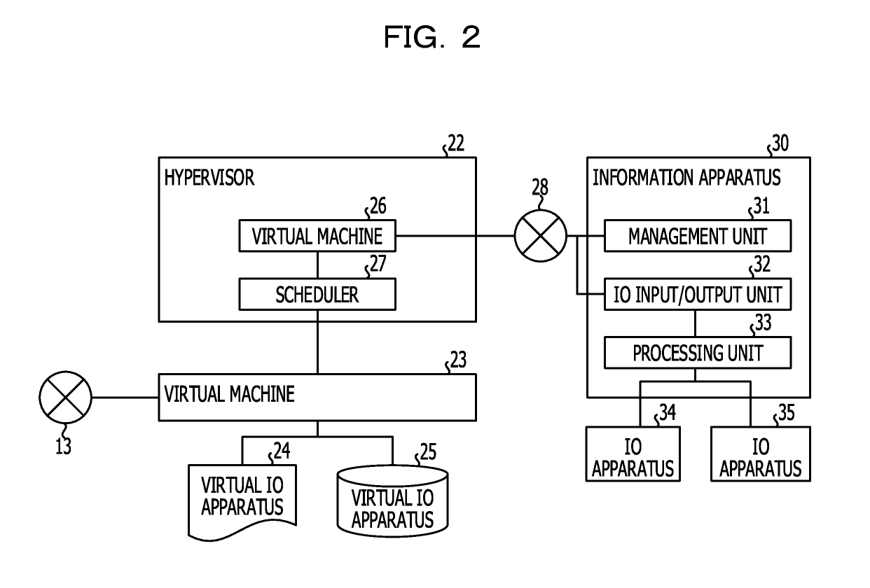

The information apparatus 10 has a function of running a virtual machine and a hypervisor for controlling the virtual machine. Referring now to FIG. 2, the virtual machine and hypervisor run by the information apparatus 10 will be described.

FIG. 2 is a diagram illustrating the hypervisor according to the first embodiment. More specifically, FIG. 2 illustrates the hypervisor run by the CPU 12 and the information apparatus 30 with which the hypervisor communicates via the IO apparatus 28.

For example, the CPU 12 runs a virtual IO 13, a hypervisor 22, a virtual machine 23, and virtual IO apparatuses 24 and 25. The virtual IO 13 is, for example, a virtual apparatus having an NIC function which allows the virtual machine 23 to receive a process execution request from a virtual machine run by other information apparatus.

The hypervisor 22 is a program for controlling the virtual machine 23 and includes an association function unit 26 and a scheduler 27. It is assumed that besides the association function unit 26 and the scheduler 27, the hypervisor 22 has functions desirable in controlling the virtual machine 23.

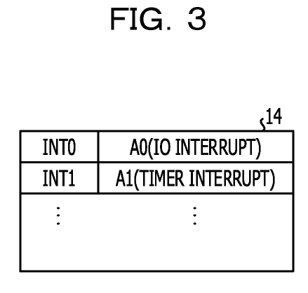

Referring now to FIGS. 3 to 9, there will be described an example of information contained in the interrupt handling table 14, the state storage area 15, the virtual machine management table 17, and the simplified-type virtual machine management table 18 stored in the memory 11.

FIG. 3 is a diagram illustrating an example of the interrupt handling table. As illustrated in FIG. 3, the interrupt handling table 14 indicates the associations between identifiers of interrupts outputted by the hypervisor 22 or virtual machine 23 and addresses storing programs to be executed when the interrupts occur. For example, an identifier “interrupt (INT) 0” is associated with an address “A0” storing a program for executing an IO interrupt. An identifier “INT1” is associated with an address “A1” storing a program for executing a timer interrupt. Although not illustrated in FIG. 3, the interrupt handling table 14 also contains the associations between the identifiers of other interrupts and addressees.

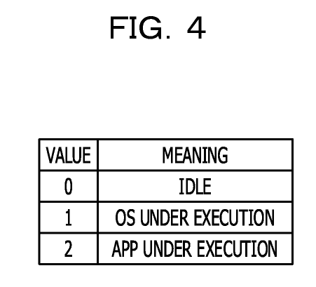

FIG. 4 is a diagram illustrating the meanings of values stored in the state storage area. The state storage area 15 is an area storing values indicating the operation states of the CPU 12. For example, as illustrated in FIG. 4, a value “0” stored in the state storage area 15 indicates that the CPU 12 is placed in an idle state. The “idle” refers to a state in which the CPU 12 is executing an idle loop after executing a program for generating a program loop.

A value “1” stored in the state storage area 15 indicates a state in which the CPU 12 is executing a program of the operating system (OS). A value “2” stored in the state storage area 15 indicates a state in which the CPU 12 is executing any application.

The CPU 12 changes the value stored in the state storage area 15 in accordance with the running program. For example, to execute an interrupt, the CPU 12 stores “1” indicating that the CPU is executing the OS, in the state storage area 15. To execute an interrupt accompanying the completion of an IO process, the CPU 12 retrieves an application which is waiting for the IO process, as well as stores “2” indicating that the CPU 12 is executing that application, in the state storage area 15.

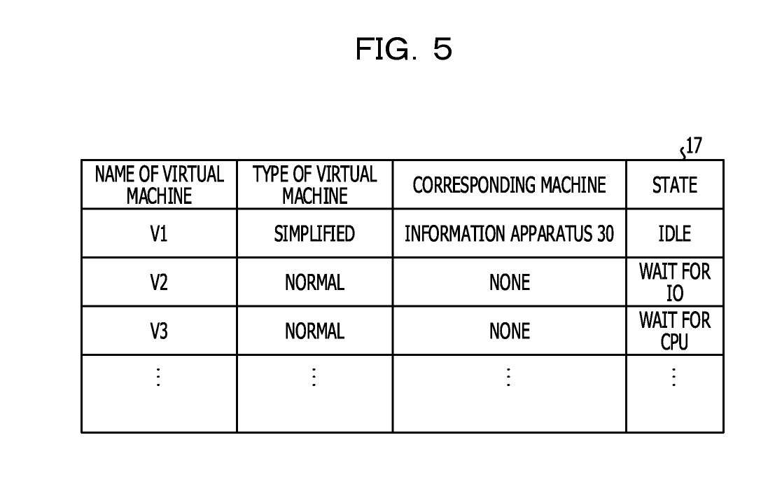

FIG. 5 is a diagram illustrating an example of the virtual machine management table. As illustrated in FIG. 5, the virtual machine management table 17 contains multiple entries each indicating the association among the name of a virtual machine, the type of the virtual machine, a machine corresponding to the virtual machine, and the state of the virtual machine. The “name of virtual machine” refers to the identifier of a virtual machine run by the CPU 12.

The “type of virtual machine” refers to information indicating whether the virtual machine having the identifier is of simplified type or normal type. The “corresponding machine” refers to, if the virtual machine is of simplified type, other information apparatus whose idle state the simplified-type virtual machine emulates. The “state” refers to the state of the virtual machine.

The “simplified-type virtual machine” refers to a virtual machine having only a function of placing the CPU 12 in an idle state. Specifically, the simplified-type virtual machine is a virtual machine that emulates only the idle state of the information apparatus 10, information apparatus 30, or other information apparatus that is not illustrated in FIG. 1. The normal-type virtual machine refers to a virtual machine that has functions other than the function of placing the CPU 12 in an idle state and that is intended to perform functions similar to those of normal information apparatuses.

For example, the virtual machine management table 17 illustrated in FIG. 5 indicates that a virtual machine “V1” is a simplified-type virtual machine that emulates only the idle state of the information apparatus 30 and is placed in an idle state. The virtual machine management table 17 also indicates that a virtual machine “V2” is a normal-type virtual machine and is waiting for IO. The virtual machine management table 17 also indicates that a virtual machine “V3” is a normal-type virtual machine and is waiting for CPU.

Note that a simplified-type virtual machine emulates only an idle state and therefore is not put into other states. Further, a simplified-type virtual machine appears to be an information apparatus corresponding thereto, to a program executed by other information apparatus. Specifically, the virtual machine “V1” appears to be the information apparatus 30, to a program executed by other information apparatus.

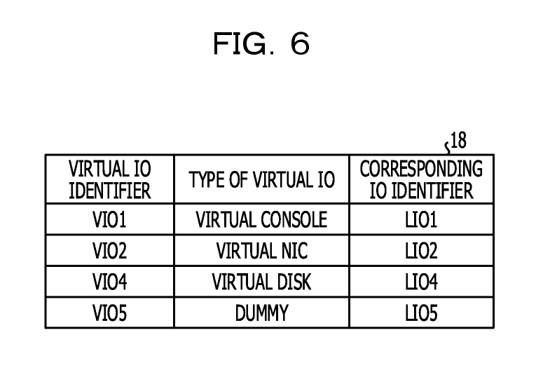

FIG. 6 is a diagram illustrating an example of the simplified-type virtual machine management table. As illustrated in FIG. 6, the simplified-type virtual machine management table 18 contains multiple entries each indicating the association among the identifier of a virtual IO, the type of the virtual IO, and an IO identifier corresponding to the virtual IO. The “identifier of a virtual IO” refers to the identifier of a virtual IO apparatus associated with the simplified-type virtual machine. The terms “type of virtual IO” refers to the type of the virtual IO apparatus. The “identifier of corresponding IO” refers to the identifier of a real apparatus corresponding to the virtual IO apparatus.

That is, the simplified-type virtual machine management table 18 is information indicating the virtual IO apparatuses corresponding to the IO apparatuses associated with the information apparatus whose idle state the simplified-type virtual machine emulates. The memory 11 contains respective simplified-type virtual machine management tables 18 corresponding to simplified-type virtual machines run by the CPU 12. The example illustrated in FIG. 6 indicates the simplified-type virtual machine management table 18 of the simplified-type virtual machine having the identifier “V1” in FIG. 5, that is, the virtual machine 23a.

The example illustrated in FIG. 6 indicates that the virtual IO having the identifier “VIO1” is a virtual console and that an IO apparatus corresponding to the virtual IO has an identifier “LIO1.” The IO apparatus having “LIO1” refers to an IO apparatus associated with the information apparatus 30.

Referring back to FIG. 1, the communication IO buffer 16 is an area for storing a process execution request that the information apparatus 10 receives from other information apparatus. Specifically, when the information apparatus 10 receives, from other information apparatus, a process execution request issued to the information apparatus 30, for example, a request to access an IO apparatus associated with the information apparatus 30, it stores the received access request in the communication IO buffer 16.

Next, the exceptional state register 20 and the program counter 21 associated with the CPU 12, the virtual machine 23, the virtual IO apparatuses 24 and 25, and a process executed by the hypervisor 22 will be described.

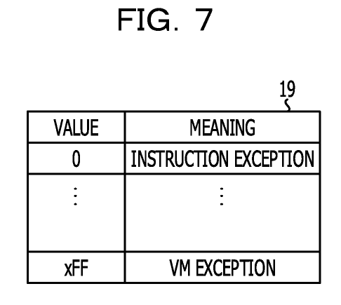

Referring first to FIG. 7, the exceptional state register 20 will be described. FIG. 7 is a diagram illustrating the meanings of values stored in the exceptional state register 20. The exceptional state register 20 stores a value indicating that an instruction exception or virtual machine (VM) exception has occurred in the virtual machine 23 run by the CPU 12.

In an example illustrated in FIG. 7, upon occurrence of an instruction exception, the virtual machine 23 stores “0” in the exceptional state register 20; upon receipt of a request to execute an inexecutable process, the virtual machine 23 stores a value “xFF” indicating a VM exception in the exceptional state register 20.

Referring back to FIG. 1, the program counter 21 is a register for storing the address of a program executed by the CPU 12. For example, where an address “A0” is stored in the program counter 21, the CPU 12 executes a program stored in the address “A0” and then updates the address stored in the program counter 21. When a new address is stored in the program counter 21, the CPU 12 executes the program. In this way, the CPU 12 sequentially executes programs.

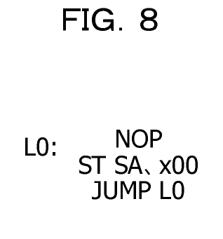

Next, the virtual machine 23 run by the CPU 12 will be described. Specifically, the virtual machine 23 is a simplified-type virtual machine having the virtual machine name “V1” and is a virtual machine that emulates the idle state of the legacy information apparatus, 30. Referring now to FIG. 8, an example of a program that runs as the virtual machine 23 will be described.

FIG. 8 is an example of an idle loop program according to the first embodiment. The example illustrated in FIG. 8 is as to a program that emulates the idle state of the information apparatus 30, of the programs that run as the virtual machine 23.

As illustrated in FIG. 8, the virtual machine 23 emulates the idle state of the information apparatus 30 using a simple program that starts from an address “L0” and that includes only “no operation (NOP), ST SA, x00, JUMP L0.” NOP refers to an instruction requesting that nothing be done. ST SA, x00 is an instruction requesting that a value “0” be set to the state storage area 15. JUMP L0 is an instruction requesting that the address pointer be moved to an address “L0.” As seen above, the virtual machine 23 is a virtual machine that emulates the idle state of the information apparatus 30 using the simple program.

In addition to the function of emulating the idle state of the information apparatus 30, the virtual machine 23 has functions of executing the following processes. For one, the virtual machine 23 has a function of identifying the value of the exceptional state register 20 and, when the value of the exceptional state register 20 is “xFF”, that is, when a process inexecutable by the virtual machine 23 occurs and thus a VM exception occurs, calling the association function unit 26. For another, the virtual machine 23 has a function of, when the value of the exceptional state register 20 indicates an IO exception, that is, when the virtual machine 23 receives an IO process execution request, updating the value of the exceptional state register 20 to “xFF.”

The virtual machine 23 also has a function of, when the exceptional state register 20 does not indicate a VM exception or IO exception, determining that a timer interrupt has occurred and updating the value of the timer. As used herein, the timer refers to a timer that the hypervisor 22 uses to select among the virtual machines “V1,” “V2,” and “V3” in accordance with the resource of the CPU 12.

Under the control of the hypervisor 22, the CPU 12 selects among the virtual machines “V1,” “V2,” and “V3” or runs them simultaneously and, when running the virtual machine “V2” or virtual machine “V3,” executes a process similar to that it executes when running a normal virtual machine.

Next, the virtual IO apparatuses 24 and 25 will be described. The virtual IO apparatuses 24 and 25 are associated with the virtual machine 23 and emulate IO apparatuses associated with the information apparatus 30 whose idle state the virtual machine 23 emulates.

That is, the virtual IO apparatuses 24 and 25 appear to be the IO apparatuses 34 and 35 associated with the information apparatus 30, to a program executed by other information apparatus. For example, the virtual IO apparatus 24 emulates the IO apparatus 34, which is a printer associated with the information apparatus 30. The virtual IO apparatus 25 emulates the IO apparatus 35 associated with the information apparatus 30.

Next, the hypervisor 22 will be described. The hypervisor 22 is a program for controlling the virtual machine 23 and the virtual IO apparatuses 24 and 25. The hypervisor 22 also has a function of selecting among the virtual machine “V1,” that is, the virtual machine 23, the virtual machine “V2,” and the virtual machine “V3” and then causing the CPU 12 to run the selected virtual machine.

The association function unit 26 of the hypervisor 22 has a function of controlling the power supply of the information apparatus 30. Specifically, when the virtual machine 23 becomes a VM exception, the association function unit 26 requests the information apparatus 30 to power itself on. When the information apparatus 30 operates, the association function unit 26 acquires a process execution request issued to the virtual machine 23, from the communication IO buffer 16 and transmits the process execution request to the information apparatus 30 via the IO apparatus 28. The association function unit 26 then instructs the scheduler 27 to stop the virtual machine 23.

The association function unit 26 also monitors the operation state of the information apparatus 30 and, when the information apparatus 30 becomes idle before a certain(predetermined) period of time elapses, instructs the scheduler 27 to power off the information apparatus 30. The association function unit 26 then instructs the scheduler 27 to run the virtual machine 23.

For example, when the association function unit 26 is called by the virtual machine 23, it receives, from the scheduler 27, notification indicating that the information apparatus whose idle state the virtual machine 23 emulates is the information apparatus 30. The association function unit 26 then powers on the information apparatus 30. The association function unit 26 then transmits the execution request stored in the communication IO buffer 16 to the information apparatus 30 identified from the virtual machine management table 17. If the information apparatus 30 is already powered on, the association function unit 26 immediately transmits the execution request stored in the communication IO buffer 16 to the information apparatus 30.

Where the CPU 12 runs multiple simplified-type virtual machines, the association function unit 26 powers on an information apparatus corresponding to a simplified-type virtual machine that has called the association function unit 26, and then transmits the execution request to the information apparatus. For example, when the association function unit 26 is called by a simplified-type virtual machine “VM4”, the association function unit 26 powers on an information apparatus whose idle state the simplified-type virtual machine “VM4” emulates, and then transmits the execution request thereto.

The scheduler 27 is a program that allocates the resources of the CPU 12 to the virtual machines “V1,” “V2,” and “V3,” sets the value of the timer using the allocated resources, and selects among the virtual machines “V1, “V2,” and “V3” using a timer interrupt. Specifically, when the value of the timer becomes a certain(predetermined) value, the scheduler 27 causes, using a timer interrupt, the CPU 12 to run one of the virtual machines “VM1,” “VM2,” and “VM3.”

When the scheduler 27 receives a process execution request issued to the virtual IO apparatuses 24 and 25, it stores the IO process execution request in the communication IO buffer 16, as well as updates the value of the exceptional state register 20 to a value indicating an IO exception. Next, the scheduler 27 refers to the simplified-type virtual machine management table 18 to identify real apparatuses corresponding to the virtual IO apparatuses, the IO apparatuses 34 and 35. The scheduler 27 then runs a virtual machine that emulates the idle state of the information apparatus associated with the identified IO apparatuses 34 and 35.

Further, when the scheduler 27 is instructed to stop the virtual machine 23 by the association function unit 26, it stops the virtual machine 23. When the scheduler 27 is instructed to run the virtual machine 23 by the association function unit 26, it resumes the virtual machine 23. That is, when the information apparatus 30 whose idle state the virtual machine 23 emulates is powered on, the scheduler 27 stops the virtual machine 23; when the information apparatus 30 is powered off, the scheduler 27 resumes the virtual machine 23.

When the association function unit 26 is called by the virtual machine 23, the scheduler 27 identifies the information apparatus 30 as the machine whose idle state the virtual machine 23 emulates, from the virtual machine management table 17. The scheduler 27 then notifies the association function unit 26 of the identified information apparatus 30.

Next, a process executed by the information apparatus 30 will be described. When the management unit 31 is requested to power on the information apparatus 30 by the association function unit 26 via the IO apparatus 28, it powers on the information apparatus 30. When the management unit 31 is requested to power off the information apparatus 30 by the association function unit 26, it powers off the information apparatus 30.

The process in which the association function unit 26 and the management unit 31 power on the information apparatus 30 is executed by issuing a power-on command using the Wake-on-LAN function which uses a local area network (LAN), the server management function of the information apparatus 10, or the like. The process in which the association function unit 26 and the management unit 31 power off the information apparatus 30 is executed by logging in to the remote control function of the OS run by the information apparatus 30 and then issuing a shut-down command. Where the information apparatus 30 has a sleep function of storing the OS state or the like and powering down the OS, the information apparatus 10 can control the power supply of the information processing apparatus 30 faster than powering it on or off.

When the IO input/output unit 32 receives an IO process execution request via the IO apparatus 28, it transfers the IO process execution request to the processing unit 33. Upon receipt of a response from the processing unit 33, the IO input/output unit 32 transmits the received response to the association function unit 26. Upon receipt of the response from the IO input/output unit 32, the association function unit 26 transmits the response to the information apparatus that has issued the IO process execution request corresponding to the received response. If the IO process execution request is a request to read data, the response refers to the read information; if the IP processing request is a request to make a printout, the response refers to information indicating that the printout has been made.

When the processing unit 33 receives the IO process execution request from the IO input/output unit 32, it executes a process on the IO apparatuses 34 and 35 in accordance with the received execution request. Upon completion of the process, the processing unit 33 outputs the response to the IO input/output unit 32.

As seen above, the information apparatus 10 runs the virtual machine 23 that emulates the idle state of the information apparatus 30. When the information apparatus 10 receives a process execution request issued to the virtual machine 23, that is, a process execution request issued to the information apparatus 30, it powers on the information apparatus 30 and transfers the process execution request to the information apparatus 30. Thus, the information system 1 can easily reduce the power consumption of the information apparatus 30.

As seen in the information apparatus 30, a legacy information apparatus whose use frequency has been reduced but is irremovable for a particular purpose, such as a mainframe, may not have a power-saving function. Further, the power consumption of a legacy information apparatus which stands idle is reduced to about 80 to 90% of that during execution of a process. On the other hand, the power consumption of an information apparatus that has been used in recent years is only one-twentieth to one-thirtieth of that of a legacy information apparatus, even when a larger load than usual is imposed. For this reason, a power-saving effect can be obtained by causing a current information apparatus to execute the idle state of a legacy information apparatus.

Further, since the virtual machine 23 only has to be able to emulate the idle state of the information apparatus 30, the above-mentioned process can be executed using a simple program. As a result, in the information system 1, the power consumption of the information apparatus 30 can be easily reduced without having to generate a complicated program.

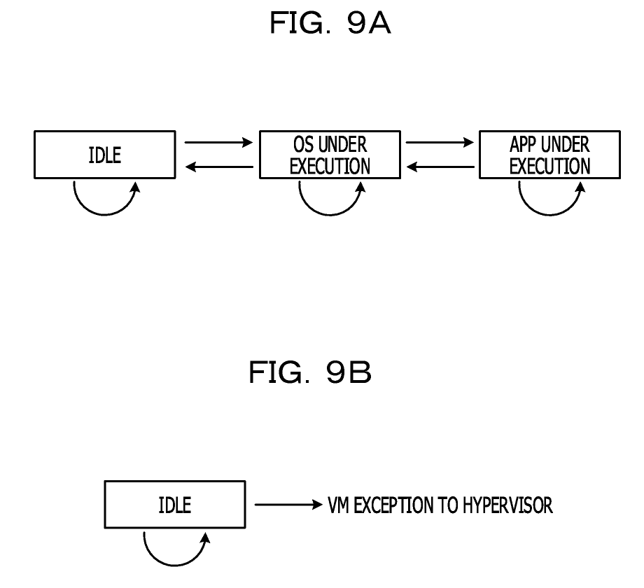

Hereafter, the state transition of the virtual machine 23 will be described. FIGS. 9A and 9B are diagrams illustrating the state transition of a virtual machine. As illustrated in FIG. 9A, a traditional virtual machine emulates all processes executed by other information apparatus and therefore changes the state of the CPU 12 to one of an idle state, an OS execution state, and an application execution state. For this reason, the traditional virtual machine includes a complicated program.

On the other hand, as illustrated in FIG. 9B, the virtual machine 23 emulates only the idle state of the information apparatus 30 and, in the execution of other process, only has to transmit a VM exception to the hypervisor. As a result, the virtual machine 23 can be achieved using a simpler program than that of the traditional virtual machine. Thus, in the information system 1, the power consumption of the information apparatus 30 can be easily reduced.

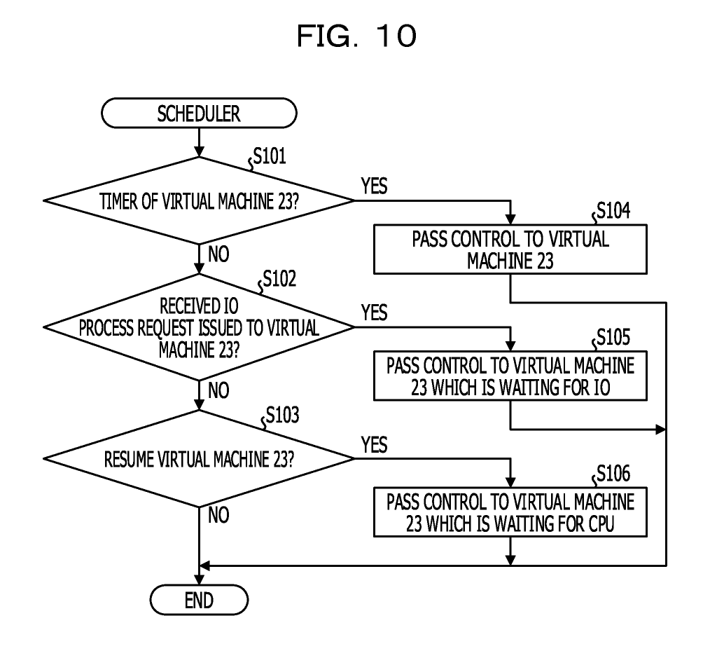

Referring now to FIG. 10, the flow of a process in which the scheduler 27 runs the virtual machine 23 will be described. FIG. 10 is a flowchart illustrating a process executed by the scheduler according to the first embodiment. In an example illustrated in FIG. 10, the scheduler 27 determines whether the timer of the virtual machine 23 has timed out (step S101).

If the timer has not timed out (NO in step S101), the scheduler 27 determines whether it has received an IO process execution request issued to the virtual machine 23 (step S102). If the scheduler 27 determines that it has not received such an IO process execution request (NO in step S102), it determines whether to resume the virtual machine 23 (step S103).

If the scheduler 27 determines that it will not resume the virtual machine 23 (NO in step S103), it ends the process. If the scheduler 27 determines that the timer of the virtual machine 23 has timed out (YES in step S101), the scheduler 27 runs the virtual machine 23 and passes control thereto (step S104), and ends the process.

If the scheduler 27 determines that it has received an IO process execution request issued to the virtual machine 23 (YES in step S102), it stores a value indicating an IO interrupt in the exceptional state register 20, as well as passes control to the virtual machine 23 which is waiting for IO (step S105) and ends the process. If the scheduler 27 determines that it will resume the virtual machine 23 (YES in step S103), it runs the virtual machine 23 which is waiting for CPU and passes control to the virtual machine 23 (step S106), and ends the process.

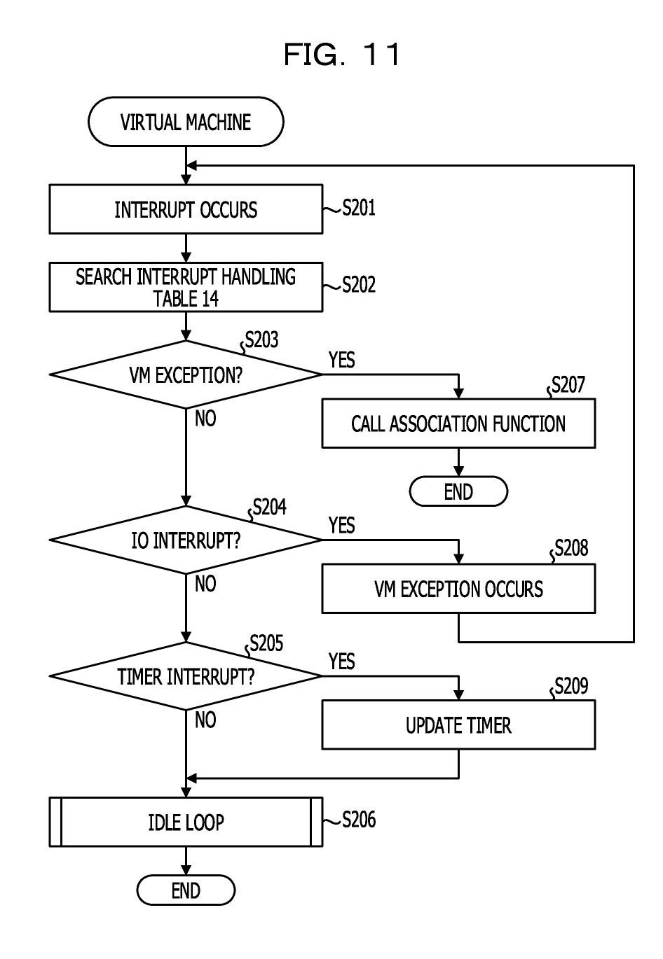

Referring now to FIG. 11, the flow of a process executed by the virtual machine 23 will be described. FIG. 11 is a flowchart illustrating a process executed by the virtual machine according to the first embodiment. In an example illustrated in FIG. 11, the virtual machine 23 is run when an interrupt occurs (step S201).

The virtual machine 23 then identifies the cause of the occurring interrupt from the values stored in the exceptional state register 20 and searches the interrupt handling table 14 to identify an address storing a program corresponding to the identified cause of the interrupt (step S202). The virtual machine 23 then causes the CPU 12 to execute an example program having the address identified step S202 as the start position so as to execute the following process.

That is, the virtual machine 23 determines whether the cause of the interrupt is a VM exception (step S203) and, if the cause is not a VM exception (NO in step S203), it determines whether the cause is an IO interrupt (step S204). If the cause of the interrupt is not an IO interrupt (NO in step S204), the virtual machine 23 determines whether the cause is a timer interrupt (step S205).

If the cause of the interrupt is not a timer interrupt (NO in step S205), the virtual machine 23 causes the CPU 12 to execute the program illustrated in FIG. 8 so as to generate an idle loop (step S206). The virtual machine 23 then ends the process. If the cause of the interrupt is a VM exception (YES in step S203), the virtual machine 23 reads the association function unit 26 (step S207) and ends the process.

If the cause of the interrupt is an IO interrupt (YES in step S204), the virtual machine 23 stores “xFF” in the exceptional state register 20 to generate a VM exception (step S208) and executes step S201 again. If the cause of the interrupt is a timer interrupt (YES in step S205), the virtual machine 23 updates the value of the timer (step S209) and then generates an idle loop (step S206).

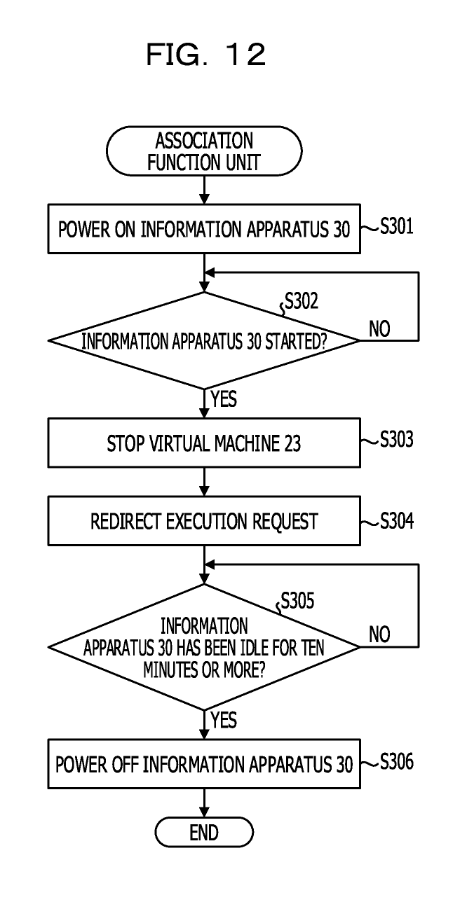

Referring now to FIG. 12, the flow of a process executed by the association function unit 26 will be described. FIG. 12 is a flowchart illustrating a process executed by the association function unit according to the first embodiment. In an example illustrated in FIG. 12, when the association function unit 26 is called by the virtual machine 23, it powers on the information apparatus 30 whose idle state the virtual machine 23 emulates (step S301).

The association function unit 26 then determines whether the information apparatus 30 has started (step S302) and, if the information apparatus 30 has not started (NO in step S302), waits for the information apparatus 30 to start. If the information apparatus 30 has started (YES in step S302), the association function unit 26 instructs the scheduler 27 to stop the virtual machine 23 (step S303), and redirects the process execution request to the information apparatus 30 (step S304).

The association function unit 26 then determines whether the information apparatus 30 has been placed in an idle state for ten minutes or more (step S305) and, if the information apparatus 30 has not been placed in an idle state for ten minutes or more (NO in step S305), executes step S305 again. If the information apparatus 30 has been placed in an idle state for ten minutes or more (YES in step S305), the association function unit 26 powers off the information apparatus 30 (step S306) and ends the process.

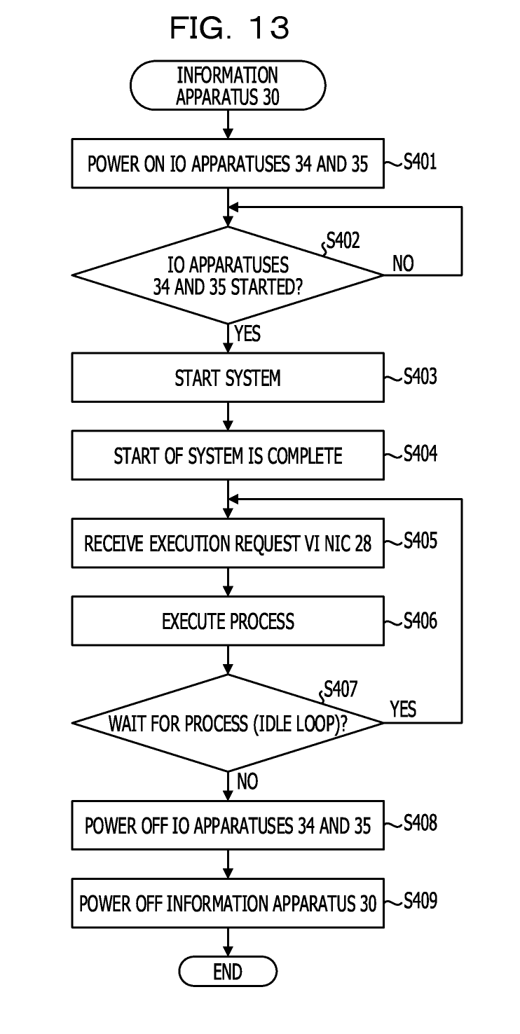

Next, the flow of a process executed by the legacy information apparatus 30 will be described. FIG. 13 is a flowchart illustrating a process executed by the legacy information apparatus according to the first embodiment. In an example illustrated in FIG. 13, when the information apparatus 30 is requested to power itself on by the association function unit 26, it powers on the IO apparatuses 34 and 35 (step S401). The information apparatus 30 then determines whether the IO apparatuses 34 and 35 have started (step S402) and, if the IO apparatuses 34 and 35 have not started (NO in step S402), it waits for the IO apparatuses 34 and 35 to start.

If the IO apparatuses 34 and 35 have started (YES in step S402), the information apparatus 30 starts the OS to be run by itself, that is, the legacy system (step S403). Upon completion of the start of the system (step S404), the information apparatus 30 receives an execution request from the association function unit 26 via the IO apparatus 28 (step S405) and executes a process corresponding to the execution request, for example, an output from a printer (step S406). The information apparatus 30 determines whether the process is on standby (an idle loop is being executed) (step S407).

If the process is on standby (YES in step S407), the information apparatus 30 returns to step S405. If the process is not on standby (NO in step S407), that is, the information apparatus 30 is requested to power itself off by the association function unit 26, the information apparatus 30 powers off the IO apparatuses 34 and 35 (step S408).

The information apparatus 30 then powers itself off (step S409) and ends the process. Note that if the information apparatus 30 receives no new execution request while repeatedly executing steps S405 to S407, it executes no process, that is, executes an idle loop until receiving a new execution request.

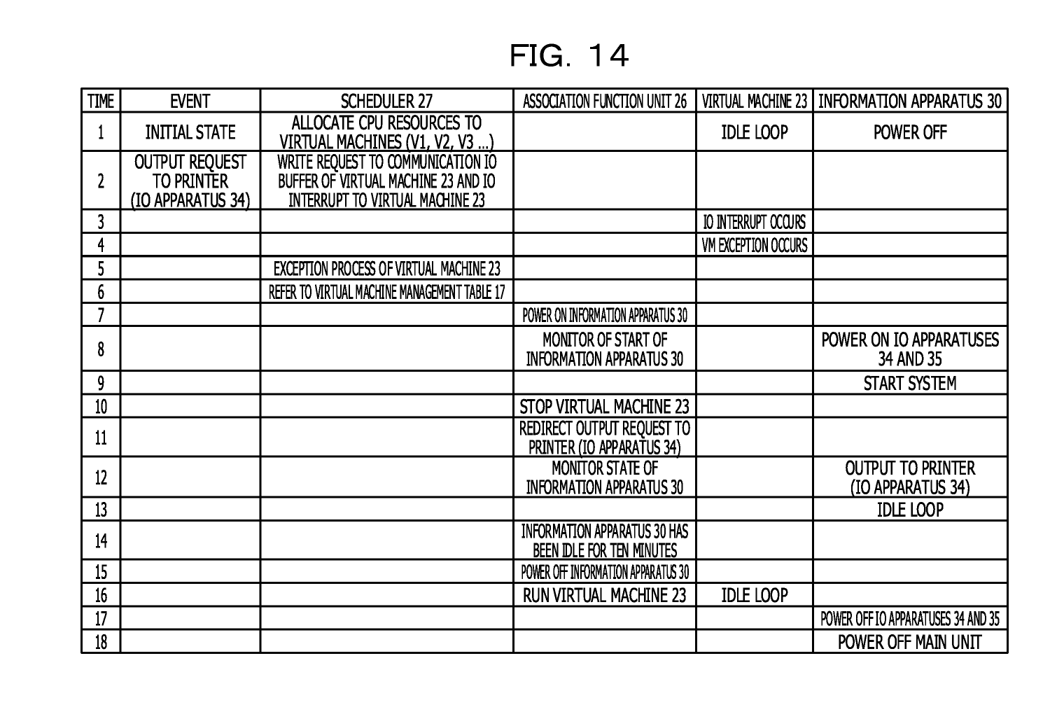

Referring now to FIG. 14, there will be described an example in which the information system 1 executes a process using the IO apparatus 34 associated with the information apparatus 30. In the following description, it is assumed that the IO apparatus 34 is a printer associated with the information apparatus 30, which is a legacy mainframe.

FIG. 14 is a sequence diagram illustrating a process that the information system according to the first embodiment executes to produce a printer output. In an example illustrated in FIG. 14, an initial-state event occurs at time “1.” The scheduler 27 then allocates resources to the virtual machines “V1,” “V2,” and “V3.” The virtual machine 23 emulates an idle loop, and the information apparatus 30 is powered off.

An output request is issued to the printer (IO apparatus 34) at time “2.” The scheduler 27 then writes the issued output request to the communication IO buffer 16 for the virtual machine 23 and starts running the virtual machine 23 using an IO interrupt. The virtual machine 23 determines that an IO interrupt has occurred, at time “3,” and determines that a VM exception has occurred and passes control to the scheduler 27, at time “4.”

The scheduler 27 determines that the a VM exception of the virtual machine 23 has occurred at time “5,” and refers to the virtual machine management table 17 at time “6,” thereby identifying the information apparatus 30 as a machine corresponding to the virtual machine 23. The association function unit 26 powers on the information apparatus 30 identified by the scheduler 27 at time “7” and monitors the start of the information apparatus 30 at time “8”.

The information apparatus 30 is powered on at time “7,” powers on the IO apparatuses 34 and 35 at time “8,” and starts the system at time “9.” The association function unit 26 stops the virtual machine 23 at time “10” and redirects the output request to the printer (IO apparatus 34) at time “11.” The association function unit 26 monitors the state of the information apparatus 30 at time “12.”

On the other hand, the information apparatus 30 produces an output to the printer (IO apparatus 34) at time “12” and executes an idle loop at time “13.” The association function unit 26 determines that the idle state of the information apparatus 30 has continued for ten minutes, at time “14” and powers off the information processing apparatus 30 at time “15.” The association function unit 26 runs the virtual machine 23 at time “16.” Thus, the virtual machine 23 resumes the idle loop. The information apparatus 30 powers off the IO apparatuses 34 and 35 at time “17” and powers itself off at time “18.”

Effect of First Embodiment

As described above, the information apparatus 10 runs the virtual machine 23 that emulates the idle state of the information apparatus 30. When the information apparatus 10 receives the process execution request issued to the information apparatus 30, it powers on the information apparatus 30 and then transfers the received execution request to the information apparatus 30.

Thus, the information apparatus 10 can easily reduce the power consumption of the information apparatus 30. That is, the virtual machine 23 does not have to emulate all processes executed by the information apparatus 30 and only has to emulate the idle state thereof. This makes the program of the virtual machine 23 simple, allowing the information apparatus 10 to easily reduce the power consumption of the information apparatus 30.

When the information processing apparatus 10 powers on the information apparatus 30, it stops the virtual machine 23. When a certain(predetermined) period of time elapses since the information apparatus 30 becomes idle, the information processing apparatus 10 powers off the information apparatus 30, as well as resumes the virtual machine 23. Thus, the information apparatus 10 can reduce the power consumption of the information apparatus 30. The information apparatus 10 allows the information apparatus 30 to appear to be usually running to a program executed by other information apparatus.

The information apparatus 10 contains the virtual machine management table 17 indicating the association between the information apparatus 30 and the virtual machine 23. The information apparatus 10 also contains other virtual machine management tables 17 each indicating the association between a legacy information apparatus omitted in FIG. 1 and a virtual machine that emulates the idle state of the legacy information apparatus.

When the information apparatus 10 receives a process execution request, it identifies a legacy information apparatus corresponding to the execution request, from the virtual machine management table 17. The information apparatus 10 then powers on the identified legacy information apparatus and transfers the execution request thereto. Thus, even if there are multiple legacy information apparatuses, the information apparatus 10 integrates virtualization fundamentals and can reduce the power consumption of the legacy environments without having to make changes to the legacy environments.

In a second embodiment below, there will be described an information system which can reduce the power consumption of a legacy information apparatus that runs a virtual machine.

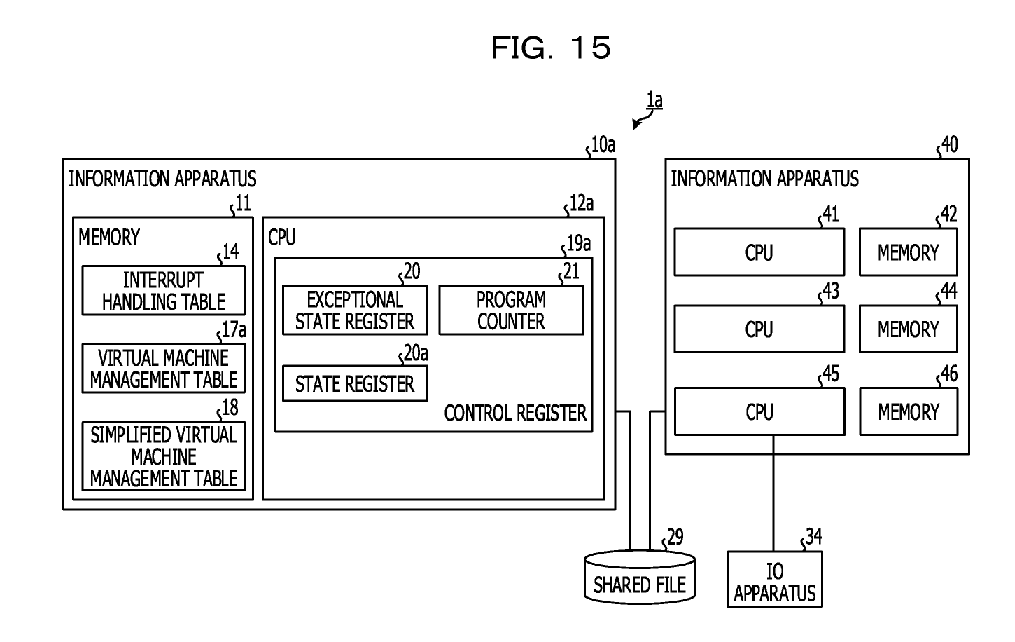

Referring first to FIG. 15, an information system la according to the second embodiment will be described. FIG. 15 is a diagram illustrating the information system according to the second embodiment. Of the components illustrated in FIG. 15, components having functions similar to those of the components of the information system 1 illustrated in FIG. 1 are given the same reference signs and will not be described.

In an example illustrated in FIG. 15, the information system is includes an information apparatus 10a, a shared file 29, an information apparatus 40, and an IO apparatus 34. As with the information apparatus 10, the information apparatus 10a includes a memory 11 and a CPU 12a. The memory 11 and the CPU 12a are coupled together via a communication line (not illustrated), such as a bus, so that they can communicate data to each other. An interrupt handling table 14 and a simplified-type virtual machine management table 18 are stored in the memory 11, as well as a virtual machine management table la. The CPU 12a includes a control register 19a. The control register 19a includes an exceptional state register 20, a program counter 21, and a state register 20a.

On the other hand, the information apparatus 40 includes CPUs 41, 43, and 45 and memories 42, 44, and 46. The CPU 41 and the memory 42, the CPU 43 and the memory 44, and the CPU 45 and the memory 46 are each associated with each other, forming units. The CPU 41 and the memory 42, the CPU 43 and the memory 44, and the CPU 45 and the memory 46 are each coupled together via a communication line (not illustrated), such as a bus, so that they can communicate data to each other. The IO apparatus 34 is associated with the unit in which the CPU 45 and the memory 46 are associated with each other. The memory 34 and the CPU 45 are coupled together via a communication line (e.g., bus or cable) so that they can communicate data to each other.

The CPU 45 runs a virtual machine and a hypervisor for controlling the virtual machine. The memory 46 is a storage device that the CPU 45 uses to perform processing. The IO apparatus 34 is associated with a virtual machine 48. The CPUs 41 and 43 and the memories 42 and 44 have functions similar to those of the CPU 45 and the memory 46 and therefore will not be described.

The information apparatus 40 can be divided into the units and thus partially powered off. For example, when the CPU 45, the memory 46, and the IO apparatus 34 are not running, the information apparatus 40 can power them off. The information apparatus 30 also has a function of, in order to cause the CPU 45 to perform processing, powering on the CPU 45, the memory 46 and the IO apparatus 34.

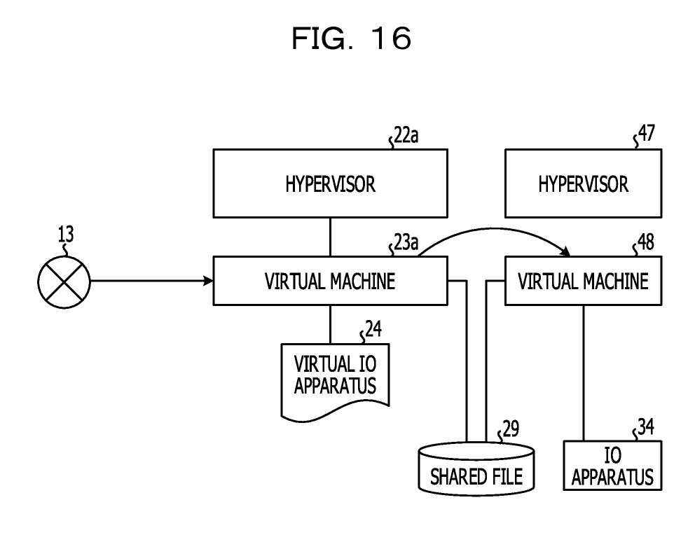

Referring now to FIG. 16, the CPU 12a, a virtual machine run by the CPU 45, and a hypervisor will be described. FIG. 16 is a diagram illustrating the hypervisor according to the second embodiment. As illustrated in FIG. 16, the CPU 12a runs a hypervisor 22a, a virtual machine 23a, and the virtual IO apparatus 24 and receives a process execution request issued to the virtual machine 23a via a virtual IO apparatus 13. The CPU 45 runs a hypervisor 47 and a virtual machine 48.

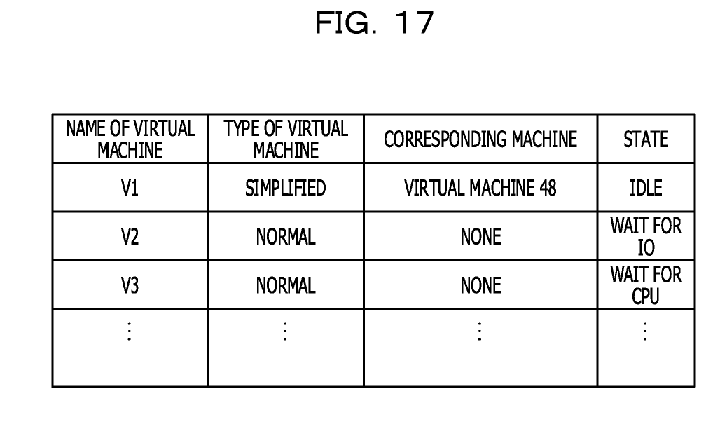

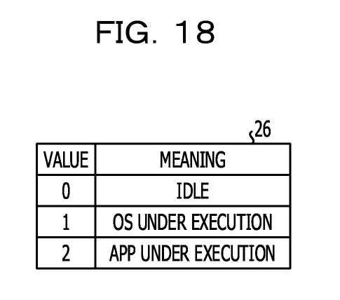

Referring now to FIGS. 17 and 18, a virtual machine management table 17a and a state register 20a will be described. FIG. 17 is a diagram illustrating an example of the virtual machine management table to the second embodiment. As illustrated in FIG. 17, the virtual machine management table 17a contains information similar to that contained in the virtual machine management table 17 illustrated in FIG. 5. The virtual machine management table 17a contains, as machines corresponding to virtual machines, pieces of information indicating virtual machines run by the information apparatus 40.

In an example illustrated in FIG. 17, the virtual machine management table 17a indicates that a machine corresponding to a virtual machine having a virtual machine name “V1,” that is, the virtual machine 23a is a virtual machine 48. As with the virtual machine 23, the virtual machine 23a is a simplified-type virtual machine. Accordingly, the virtual machine management table 17a indicates that the virtual machine 23a is a virtual machine that emulates the idle state of the virtual machine 48.

FIG. 18 is a diagram illustrating the meanings of values stored in the state register 20a. The state register 20a is a register for storing a value indicating the operation state of the CPU 12a. As illustrated in FIG. 18, a value “0” stored in the state register 20a indicates that the CPU 12a is placed in an idle state.

A value “1” stored in the state register 20a indicates that the CPU 12 is executing a program of the OS. A value “2” stored in the state register 20a indicates that the CPU 12 is executing any application.

The CPU 12a changes the value stored in the state register 20a in accordance with the running program. For example, to execute an interrupt, the CPU 12a stores “1” in the state register 20a; to execute an interrupt associated with the completion of the IO process, the CPU 12a stores “2” indicating that it is executing an application, in the state register 20a.

Next, the virtual machines 23a and 48 will be described. The virtual machine 48 has a function of executing a process on the IO apparatus 34, as well as a function of changing the state of the CPU 45 to an idle state.

On the other hand, the virtual machine 23a has only a function of changing the state of the CPU 12a to an idle state, as the virtual machine 48 does so with respect to the CPU 45, of the functions of the virtual machine 48. Specifically, the virtual machine 23a has only a function of storing “0” in the state register 20a and changing the state of the CPU 12a to an idle state. To emulate the idle state of the virtual machine 48, the virtual machine 23a stores “0” in the state register 20a to change the state of the CPU 12a to an idle state.

When an IO interrupt or timer interrupt occurs, the virtual machine 23a or other virtual machines run by the CPU 12a changes the state of the CPU 12a from an idle state to other. For example, when an IO interrupt occurs, the virtual machine 23a causes the CPU 12a to read a program having an address (A0) corresponding to the IO interrupt from the interrupt handling table 14 on the memory 11 and then execute the read program.

At this time, the virtual machine 23a sets a value “1” to the state register 20a. When an interrupt occurs in association with the completion of the IO process, the virtual machine 23a sets a value “2” to the state register 20a and resumes an application which is waiting for an IO process.

As with the virtual machine 23, when the virtual machine 23a receives a process execution request, it stores “xFF” in the exceptional state register 20. The virtual machine 23a then calls the hypervisor 22a. In such a case, the hypervisor 22a determines that the virtual machine 23a has become a VM exception and executes a process of moving the virtual machine 23a to the CPU 45, that is, migration.

Referring back to FIG. 16, the hypervisor 22a and a hypervisor 47 have a migration function which moves a virtual machine by encapsulation in which hardware information of the virtual machine 23a or virtual machine 48 is handled as files. For example, the hypervisor 22a moves the virtual machine 23a to the information apparatus 40 by storing encapsulated data of the virtual machine 23a in the shared file 29 and then causing the hypervisor 47 to read the stored data.

At this time, the hypervisor 22a notifies the hypervisor 47 of a function desirable in causing the virtual machine 23a to run as the virtual machine 48, that is, a function desirable in responding to a process execution request received by the virtual machine 23a. The hypervisor 47 then dynamically reads a file for performing the notified function when reading the files of the virtual machine 23a from the shared file 29, and executes the read file. Thus, the hypervisor 47 causes the virtual machine 23a to run as the virtual machine 48.

On the other hand, when reading data of the virtual machine 48 from the shared file 29, the hypervisor 22a reads and executes only a function of changing the state of the CPU for running a virtual machine to an idle state, of the functions of the virtual machine 48. That is, in running a virtual machine, the CPU 12a causes the virtual machine to run as the virtual machine 23a, and the CPU 45 causes the same virtual machine to run as the virtual machine 48.

The hypervisor 22a has a function similar to that of the hypervisor 22. When the virtual machine 23a becomes a VM exception, the hypervisor 22a encapsulates the data of the virtual machine 23a. If the hypervisor 22a has already received a process execution request issued to the virtual machine 23a, it encapsulates the received execution request together with the data of the virtual machine 23a and stores it in the shared file 29. That is, the hypervisor 22a stores the execution request in a memory area of the virtual machine 23a and executes migration for each of the memory areas of the virtual machine 23a.

The hypervisor 22a then refers to the virtual machine management table 17a to identify the virtual machine 48 as a virtual machine corresponding to the virtual machine 23a. The hypervisor 22a then requests the CPU 45 for running the virtual machine 48 to run the hypervisor 47. The information apparatus 40 then supplies power to the CPU 45 to start running the hypervisor 47.

When the CPU 45 starts running the hypervisor 47, the hypervisor 22a notifies the hypervisor 47 of the migration of the virtual machine 48. The hypervisor 47 then dynamically reads, from the shared file 29, the data of the virtual machine 23a, as well as data for performing the functions of the virtual machine 48. The hypervisor 47 then causes the virtual machine 23a to run as the virtual machine 48.

On the other hand, the hypervisor 22a monitors the state of the CPU 45 via the hypervisor 47. When a certain(predetermined) period of time elapses after the state of the CPU 45 is changed to an idle state, the hypervisor 22a requests the hypervisor 47 to move the virtual machine 48. The hypervisor 47 then stores the encapsulated data of the virtual machine 48 in the shared file 29. The hypervisor 22a then runs the virtual machine 48 as the virtual machine 23a by executing, from the shared file 29, only a function of changing the state of the CPU to an idle state, of the functions of the virtual machine 48.

The hypervisor 47 has the function of moving the virtual machine 23a as the virtual machine 48 or moving the virtual machine 48 as the virtual machine 23a, as well as a function of controlling the virtual machine run by the CPU 45, that is, a function of a typical hypervisor. The virtual machine 48 has the function of executing various processes on the IO apparatus 34, as well as any function of a traditional virtual machine.

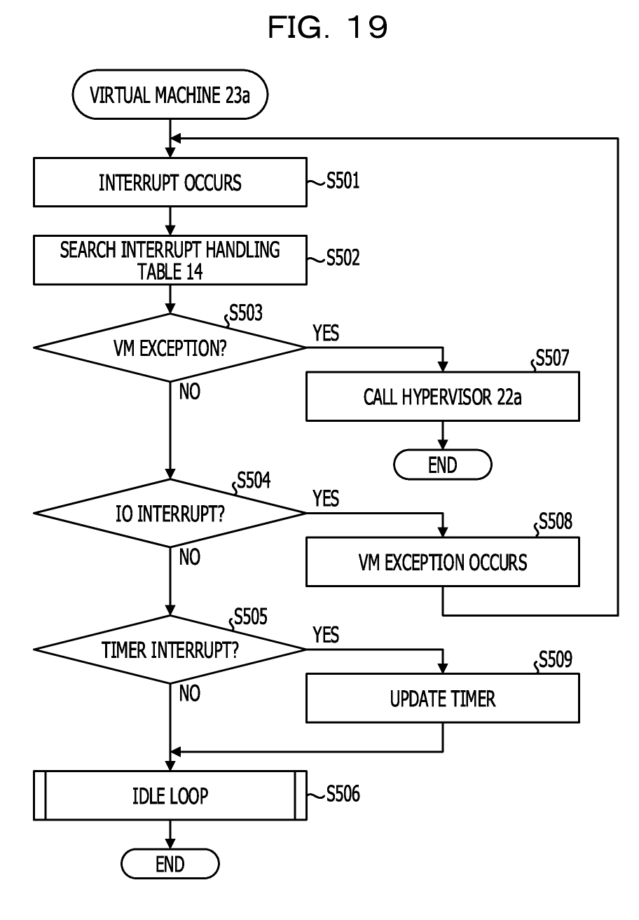

Referring now to FIG. 19, the flow of a process executed by the virtual machine 23a will be described. FIG. 19 is a flowchart illustrating a process executed by the virtual machine according to the second embodiment. Of the steps illustrated in FIG. 19, steps S501 to S505, S508, and S509 are similar to steps S201 to S205, S208, and S209 illustrated in FIG. 12 and therefore will not be described.

In an example illustrated in FIG. 19, if the cause of an interrupt is not a timer interrupt (NO in step S505), or if the timer is updated (step S509), the virtual machine 23a executes the following process. That is, the virtual machine 23a stores “0” in the state register 20a and changes the state of the CPU 12a to an idle state so as to execute an idle loop (step S506). If a VM exception occurs, or if the cause of an interrupt is a VM exception (YES in step S503), the virtual machine 23a stores “xFF” in the exceptional state register 20, calls the hypervisor 22a (step S507), and ends the process.

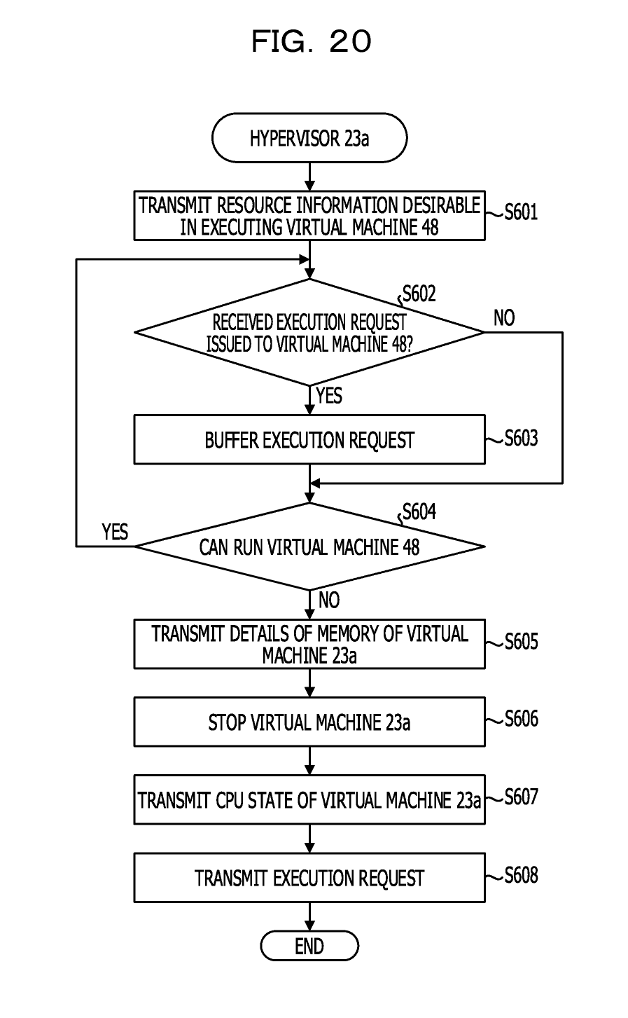

Referring now to FIG. 20, there will be described a process in which the hypervisor 22a causes the legacy information apparatus 40 to move the virtual machine 23a. FIG. 20 is a first flowchart illustrating a process in which the virtual machine according to the second embodiment migrates to the legacy environment. For example, the hypervisor 22a transmits resource information desirable in running the virtual machine 48 to the hypervisor 47 of the information apparatus 40 (step S601). That is, the hypervisor 22a notifies the hypervisor 47 of a function desirable in executing a process.

The hypervisor 22a then determines whether it has received a process execution request issued to the virtual machine 48, that is, it has received a process execution request issued to the virtual machine 23a (step S602). If the hypervisor 22a has received a process execution request issued to the virtual machine 48 (YES in step S602), it buffers the received execution request (step S603). The hypervisor 22a then determines whether it can run the virtual machine 48 (step S604).

If the hypervisor 22a determines that it may not be able to run the virtual machine 48 (NO in step S604), it transmits details of the memory used by the virtual machine 23a to the hypervisor 47 (step S605). That is, the hypervisor 22a starts migration. The hypervisor 22a then stops the virtual machine 23a (step S606) and transmits the CPU state of the virtual machine 23a to the hypervisor 47 (step S607).

The hypervisor 22a then transmits the buffered process execution request to the hypervisor 47 (step S608) and ends the process. If the hypervisor 22a has not received a process execution request issued to the virtual machine 48 (NO in step S602), it executes step S604. If the hypervisor 22a determines that it can run the virtual machine 48 (YES in step S604), it executes step S602.

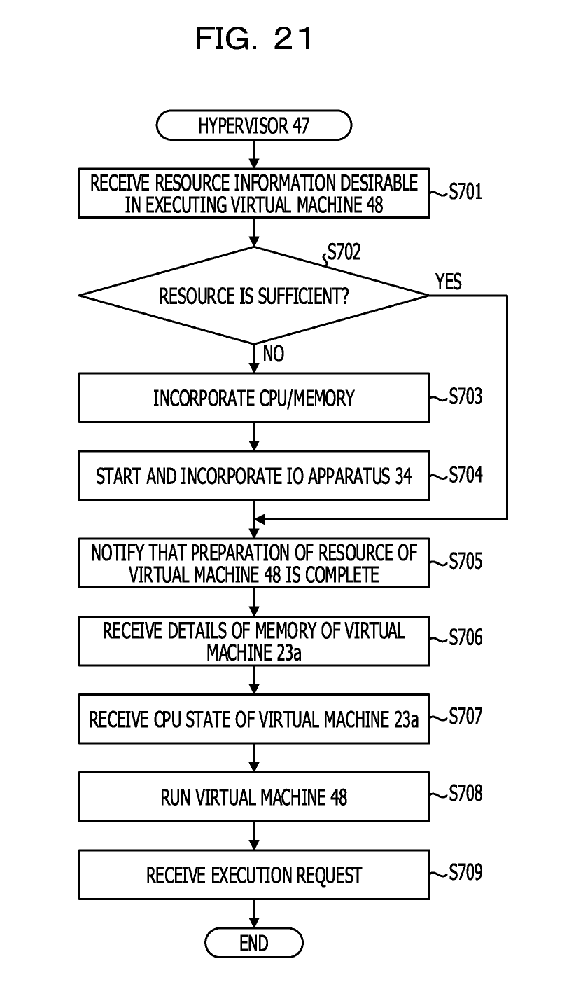

Referring now to FIG. 21, there will be described the flow of a process in which the hypervisor 47 causes the moved virtual machine 23a to run as the virtual machine 48. FIG. 21 is a second flowchart illustrating a process in which the virtual machine according to the second embodiment migrates to the legacy environment. First, the hypervisor 47 receives resource information desirable in running the virtual machine 48 transmitted in step S601 of FIG. 20 (step S701).

The hypervisor 47 then make a comparison with the received resource information to determine whether the resource for the CPU 45, the memory 46 or the like is sufficient (step S702). If the hypervisor 47 determines that the resource is not sufficient (NO in step S702), it incorporates other CPU, 43, other memory, 44, or the like (step S703). The hypervisor 47 then starts and incorporates the IO apparatus 34 (step S704).

The hypervisor 47 then notifies the hypervisor 22 that the preparation of the resource of the virtual machine 48 is complete (step S705). The hypervisor 22a then starts migration and transmits details of the memory of the virtual machine 23a (step S605 of FIG. 20). Thus, the hypervisor 47 receives details of the memory of the virtual machine 23a (step S706) and then receives the CPU state of the virtual machine 23a (step S707).

The hypervisor 47 then runs the virtual machine 23a as the virtual machine 48 (step S708), receives the execution request transmitted by the hypervisor 22a in step S608 of FIG. 20 (step S709), and ends the process. If the hypervisor 47 determines that the resource is sufficient (YES in step S702), it skips steps S703 and S704 and executes step S705.

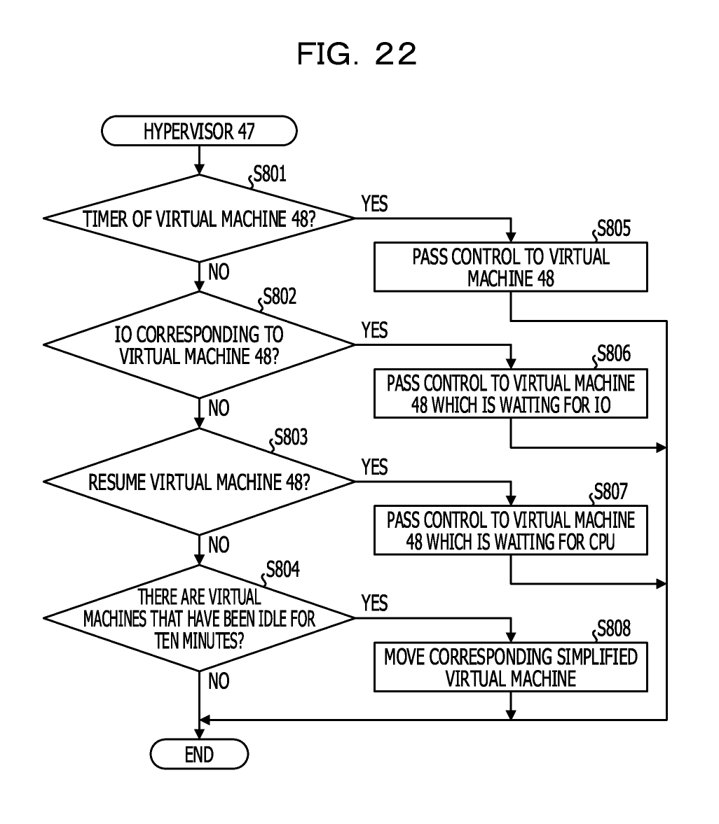

Referring now to FIG. 22, the flow of a process executed by the hypervisor 47 will be described. FIG. 22 is a flowchart illustrating a process executed by the legacy hypervisor according to the second embodiment. Steps S801 to S803 and S805 to S807 of FIG. 22 are similar to steps S101 to S103 and S104 to 106 of FIG. 10 and therefore will not be described.

For example, if the hypervisor 47 determines that it will not resume the virtual machine 48 (NO in step S803), it determines whether there is a virtual machine that has been placed in an idle state for ten minutes (step S804). If there is no such virtual machine (NO in step S804), the hypervisor 47 ends the process.

If there is a virtual machine that has been placed in an idle state for ten minutes (YES in step S804), the hypervisor 47 executes the following process. That is, the hypervisor 47 regards this virtual machine as a simplified virtual machine and moves it to the information apparatus 10a (step S808).

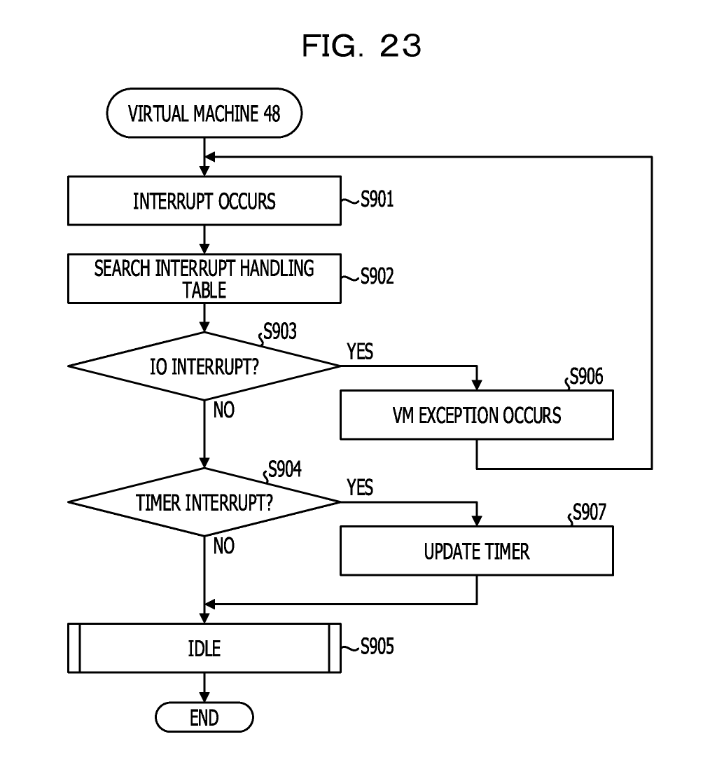

Referring now to FIG. 23, the flow of a process executed by the virtual machine 48 will be described. FIG. 23 is a flowchart illustrating a process executed by the legacy virtual machine according to the second embodiment. In the following description, it is assumed that the memory 46 contains an interrupt handling table similar to the interrupt handling table 14 contained in the memory 11.

For example, the virtual machine 48 is executed when an interrupt occurs (step S901). The virtual machine 48 then searches the interrupt handling table to identify an address storing a program corresponding to the identified interrupt (step S902). The virtual machine 48 then causes the CPU 45 to execute an example program having the address identified in step S902 as the start position so as to execute the following process.

That is, the virtual machine 48 determines whether the cause of the interrupt is an IO interrupt (step S903). If the cause of the interrupt is not an IO interrupt (NO in step S903), the virtual machine 48 determines whether the cause is a timer interrupt (step S904).

If the cause of the interrupt is not a timer interrupt (NO in step S904), the virtual machine 48 changes the state of the CPU 45 to an idle state (step S905) and ends the process. If the cause of the interrupt is an IO interrupt (YES in step S903), the virtual machine 48 generates a VM exception (step S906) and executes step S901.

If the cause of the interrupt is a timer interrupt (YES in step S904), the virtual machine 48 updates the value of the timer and then changes the state of the CPU to an idle state (step S905).

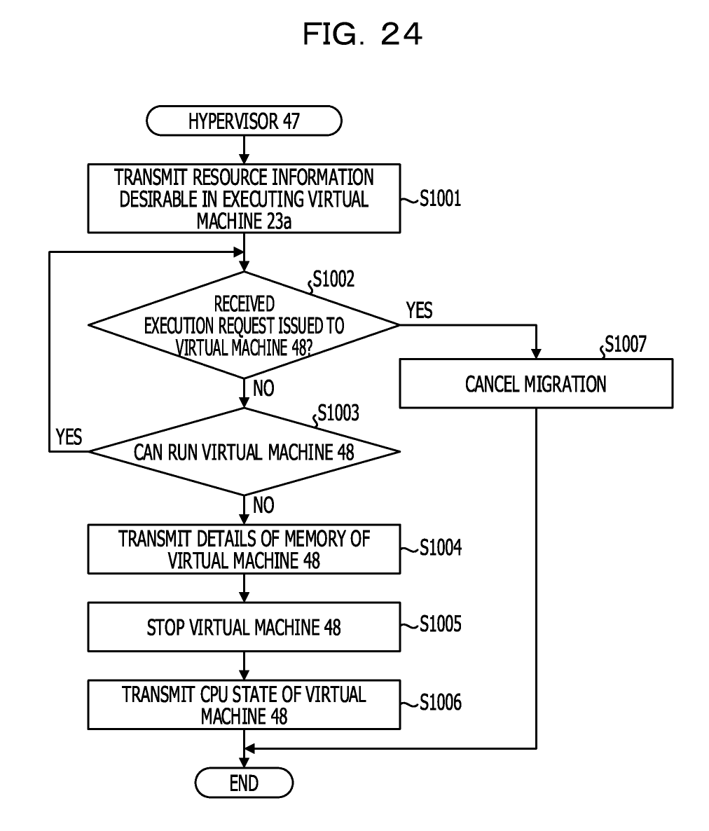

Referring now to FIG. 24, there will be described the flow of a process that the hypervisor 47 executes to move the virtual machine 48 from the information apparatus 40 to the information apparatus 10a. FIG. 24 is a first flowchart illustrating a process in which the virtual machine according to the second embodiment migrates to the current system. Steps S1001, S1002, and S1003 to S1006 to be executed by the hypervisor 47 in FIG. 24 are similar to steps S601, S602, and S604 to S607 executed by the hypervisor 22a in FIG. 20 and therefore will not be described.

For example, if the hypervisor 47 determines that it has received a process execution request issued to the virtual machine 48 (YES in step S1002), it cancels the movement of the virtual machine 48, that is, migration (step S1007) and ends the process. In contrast, if the hypervisor 47 has not received a process execution request issued to the virtual machine 48 (NO in step S1002), it determines whether it can run the virtual machine 48 (step S1003). The hypervisor 47 transmits the CPU state of the virtual machine 48 to the hypervisor 22a (step S1006) and ends the process without doing transmission of an execution request, or the like.

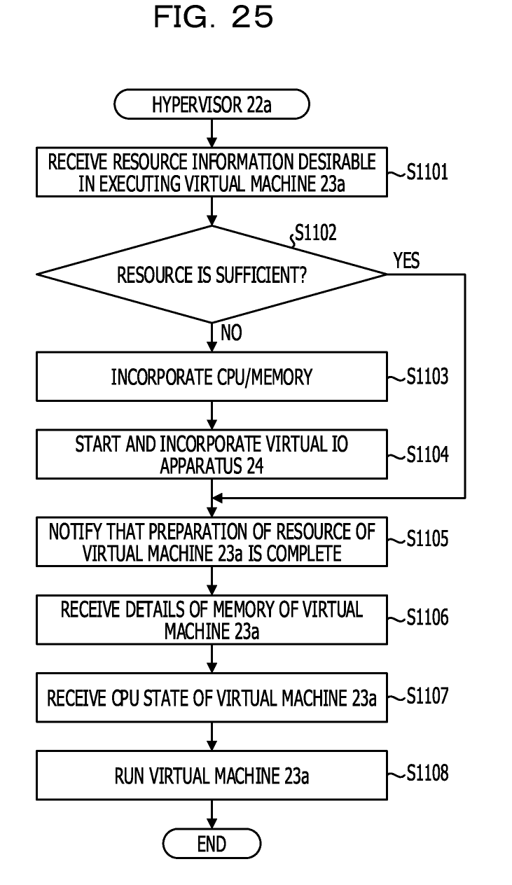

Referring now to FIG. 23, there will be described the flow of a process that the hypervisor 22a executes to move the virtual machine 48 from the information apparatus 40 to the information apparatus 10a. FIG. 25 is a second flowchart illustrating a process in which the virtual machine according to the second embodiment migrates to the current system. Of the steps illustrated in FIG. 25, steps S1101 to S111103 and S1105 to S1108 to be executed by the hypervisor 22a are similar to steps S701 to S703 and S705 to S708 illustrated in FIG. 21 and therefore will not be described.

For example, if the hypervisor 22a incorporates the CPU 12a and the memory 11 (step S1103), it starts and incorporates the virtual IO apparatus 24 (step S1104) and then starts migration (step S1105 to S1107). The hypervisor 22a also runs the virtual machine 23a (step S1108) and ends the process without receiving an execution request.

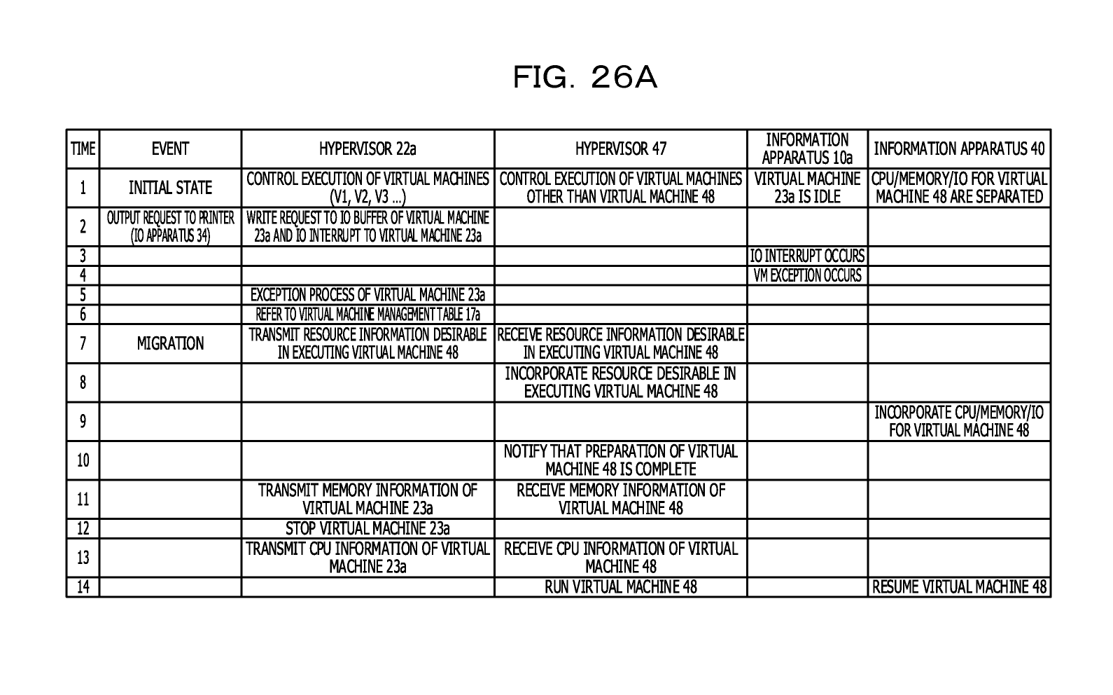

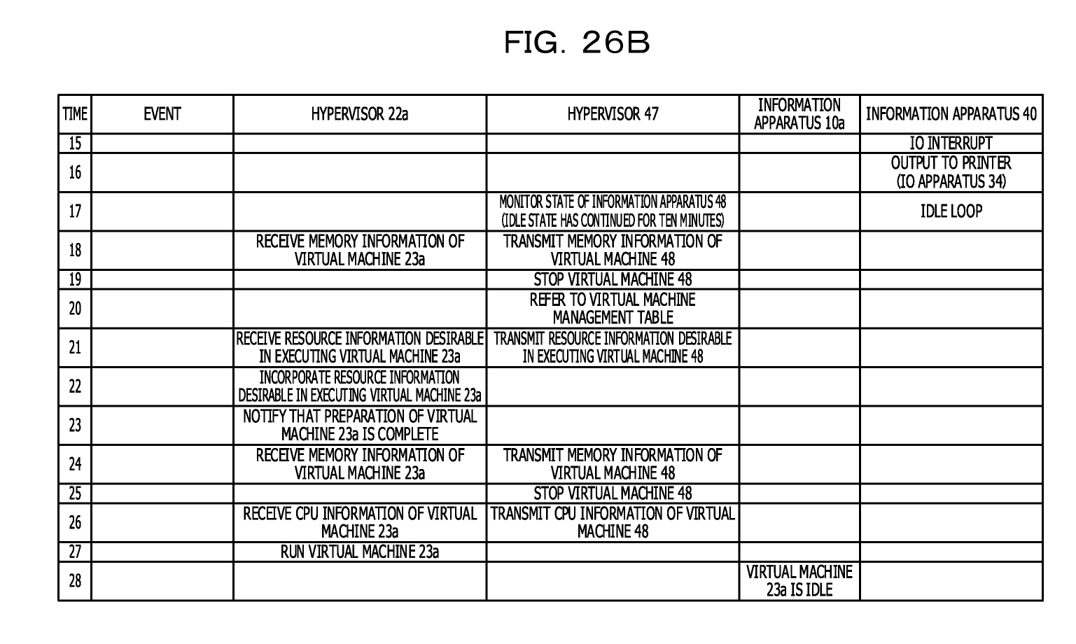

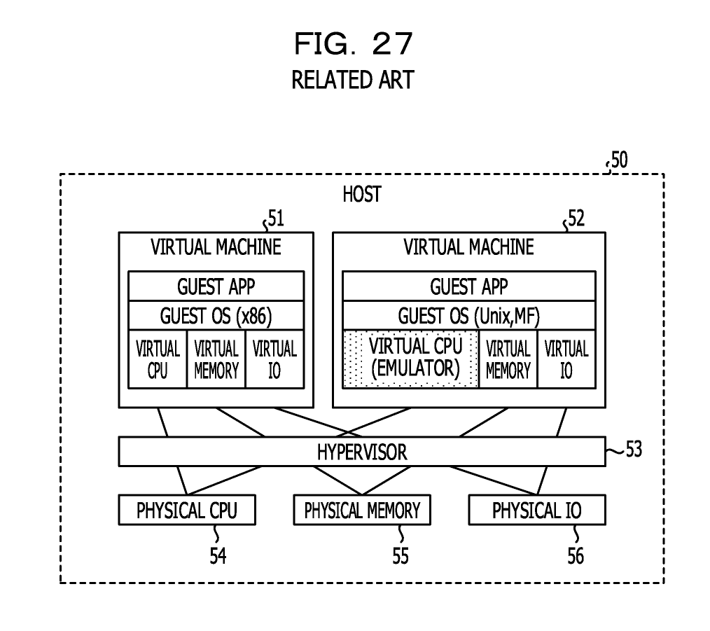

Referring now to FIGS. 26A and 26B, there will be described an example in which the information system is executes a process using the IO apparatus 34 associated with the information apparatus 40. FIGS. 26A and 26B are sequence diagrams illustrating the flow of a process that the information system according to the second embodiment executes to produce a printer output. In an example illustrated in FIGS. 26A and 26B, an initial-state event occurs at time “1.” The hypervisor 22a then allocates resources to the virtual machines “V1,” “V2,” and “V3.”

The hypervisor 47 controls the execution of virtual machines other than the virtual machine 48. In the information apparatus 10a, the virtual machine 23a emulates the idle state of the virtual machine 48. In the information apparatus 40, a CPU, memory, and IO for the virtual machine 48 are separated from each other and powered off.

An output request is issued to the printer (IO apparatus 34) at time “2.” The hypervisor 22a then writes the issued output request to an IO buffer for the virtual machine 23a and starts running the virtual machine 23a using an IO interrupt. The virtual machine 23a determines that an IO interrupt has occurred, at time “3” and determines that a VM exception has occurred and passes control to the hypervisor 22a at time “4.”

The scheduler 27 determines that the a VM exception of the virtual machine 23a has occurred, at time “5” and refers to the virtual machine management table 17a at time “6” to identify the virtual machine 48 as a machine corresponding to the virtual machine 23a. The hypervisor 22a starts migration at time “7” and transmits resource information desirable in running the virtual machine 48 to the information apparatus 40. The hypervisor 47 receives the resource information.

The hypervisor 47 incorporates resource desirable in running the virtual machine 48 at time “8.” For this reason, the information apparatus 40 incorporates a CPU, memory, and IO for the virtual machine 48 at time “9.” The hypervisor 47 then transmits notification indicating that the preparation of the virtual machine 48 is complete, to the hypervisor 22a at time “10.”

For this reason, the hypervisor 22a transmits memory information of the virtual machine 23a at time “11”, and the hypervisor 47 receives the memory information of the virtual machine 48. At this time, the hypervisor 47 also receives the process execution request received by the virtual machine 23a. The hypervisor 22a stops the virtual machine 23a at time “12” and transmits the CPU information of the virtual machine 23a to the hypervisor 47 at time “13.”

The hypervisor 47 then receives CPU information of the virtual machine 48, and runs the virtual machine 48 at time “14.” The information apparatus 40 handles an IO interrupt and produces a printer (IO apparatus 34) output at time “15” and is put into an idle state at time “16.” At this time, the hypervisor 47 is monitoring the state of the virtual machine 48 and determines that the idle state has continued for ten minutes. Accordingly, the hypervisor 47 transmits memory information of the virtual machine 48 to the hypervisor 22a at time “18.” The hypervisor 22a then receives the memory information of the virtual machine 48 as memory information of the virtual machine 23a.

The hypervisor 47 stops the virtual machine 48 at time “19” and refers to the virtual machine management table at time “20.” The hypervisor 47 transmits resource information desirable in running the virtual machine 48 to the hypervisor 22a at time “21.” On the other hand, the hypervisor 22a receives the resource information desirable in running the virtual machine 23a, and incorporates the resource desirable in running the virtual machine 23a at time “22.” The hypervisor 22a then transmits notification indicating that the preparation of the virtual machine 23a is complete, to the hypervisor 47. The hypervisor 47 transmits memory information of the virtual machine 48 to the hypervisor 22a at time “24.”

The hypervisor 22a receives the memory information of the virtual machine 23a at time “24.” The hypervisor 22a stops the virtual machine 48 at time “25” and transmits CPU information of the virtual machine 48 to the hypervisor 22a at time “26.”

The hypervisor 22a receives the CPU information of the virtual machine 23a, and runs the virtual machine 23a at time “27.” As a result, the virtual machine 23a emulates the idle state of the virtual machine 48 at time “28.” Since the migration is complete at time “26,” the information apparatus 40 separates the resource used by the virtual machine 48 and stops the power supply.

Effect of Second Embodiment

As described above, the information apparatus 10a runs, as the virtual machine 23a, only the idle state of the virtual machine 48 run by the legacy information apparatus 40. When the information apparatus 10a receives a process execution request issued to the virtual machine 23a, that is, a process execution request issued to the virtual machine 48, it executes migration for moving the virtual machine 23a to the information apparatus 40. The information apparatus 40 runs the moved virtual machine 23a as the virtual machine 48. The information apparatus 10a then transmits the process execution request issued to the virtual machine 23a, to the information apparatus 40.

Thus, when a process execution request is issued to the legacy environment, the information apparatus 10a powers on only the resource for running the virtual machine 48. As a result, the power consumption of the legacy environment can be reduced.

The information apparatus 40 has the function of, when the virtual machine 48 has been placed in an idle state for a certain(predetermined) period of time, moving the virtual machine 48 to the information apparatus 10a. When the virtual machine 48 is moved, the information apparatus 10a runs only the idle state of the virtual machine 48 as the virtual machine 23a. Thus, the information apparatus 10a can reduce the power consumption of the information apparatus 40 without having to generate a complicated virtual machine. As a result, the information apparatus 10a can reduce the power consumption of the legacy environment.

Further, the information apparatus 10a contains, in the form of the virtual machine management table 17a, association information indicating the associations between virtual machines run by other information apparatuses and simplified-type virtual machines that emulate the idle state of the virtual machines. When a simplified-type virtual machine run by the information apparatus 10a receives a process execution request, the information apparatus 10a moves the simplified-type virtual machine to an information apparatus that runs a virtual machine corresponding to the simplified-type virtual machine.

Accordingly, even when the information apparatus 10a are running simplified-type virtual machines corresponding to virtual machines run by multiple information apparatuses, it can execute migration of a virtual machine properly. As a result, the information apparatus 10a integrates virtualization fundamentals and can reduce the power consumption of the legacy environment without having to make a change to the legacy environment.

Further, in order to move a virtual machine, the information apparatus 10a instructs the destination information apparatus to add a function desirable in executing a process. Thus, the information apparatus 10a can avoid a situation in which the process is difficult to execute after the migration of the virtual machine.

The information apparatus 40 includes multiple computation units for executing a virtual machine and has a function of separating a computation unit which is running no virtual machine and stopping the power supply to such a computation unit. Thus, in the execution of simplified-type virtual machines corresponding to multiple virtual machines, the information apparatus 10a can reduce the power consumption of the legacy information apparatus.

While the embodiments have been described, other various embodiments may be carried out. Other embodiment will be described below as a third embodiment.

(1) Legacy Information Apparatus

FIG. 1 illustrates one legacy information apparatus, 30. However, the embodiment is not limited thereto. For example, even if there are multiple information apparatuses 30a to 30d which have functions similar to those of the information apparatus 30, the information apparatus 10 runs virtual machines 23b to 23e that emulate the idle state of the information apparatuses 30a to 30d. When one of the virtual machines 23b to 23e receives a process execution request, the information apparatus 10 may power on an information apparatus whose idle state the virtual machine having received the process execution request emulates and may transmit the process execution request to the information apparatus.

(2) About Embodiments

The respective functions of the information apparatuses 10 and 10a may be combined unless the functions are contradictory to each other. For example, the information apparatus 10a has functions similar to those of the information apparatus 10 and runs both the virtual machine 23, which emulates the idle state of the information apparatus 30, and the virtual machine 23a, which emulates the idle state of the virtual machine 48. When the virtual machine 23 receives a process execution request, the information apparatus 10a may power on the information apparatus 30 and transmit the execution request; when the virtual machine 23a receives a process execution request, it may move the virtual machine 23a to the information apparatus 40.

The programs, such as the hypervisors 22, 22a, and 47 and the virtual machines 23, 23a, and 48, can be achieved by executing previously prepared programs on a computer, such as a personal computer or workstation. These programs can be distributed via a network, such as the Internet. These programs are recorded in a computer-readable recording medium, such as a hard disk, a flexible disk (FD), a compact disc read-only memory (CD-ROM), a magneto-optical disc (MO), and a digital versatile disc (DVD). These programs may be executed by reading them from the recording medium using a computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing method executed by an information processing apparatus, the information processing method comprising:
running a virtual machine that emulates an idle state of other information apparatus;
powering on the other information apparatus when receiving a process execution request issued to the running virtual machine; and
transferring the received execution request to the powered-on other information apparatus.

2. The information processing method according to claim 1, the method further comprising:
powering off the other information apparatus when a certain period of time elapses after the other information apparatus is put into an idle state;
stopping the virtual machine when the other information apparatus is powered on; and
resuming the virtual machine when the other information apparatus is powered off.

3. The information processing method according to claim 1, the method further comprising:
when receiving the process execution request, identifying an information apparatus corresponding to the virtual machine to which the process execution request has been issued, on the basis of a correspondence between the other information apparatus and the virtual machine that emulates an idle state of the other information apparatus; and
powering on the identified information apparatus.

4. An information processing method executed by an information processing apparatus, the information processing method comprising:
running a virtual machine run by other information apparatus with an idle state;
moving the virtual machine to the other information apparatus when receiving a process execution request issued to the running virtual machine with the idle state; and
transmitting the received execution request to the other information apparatus.

5. The information processing method according to claim 4,
wherein the other information apparatus moves the virtual machine to the information apparatus when the virtual machine is placed in the idle state for a certain period of time, and
wherein the information processing method further comprising:
running the virtual machine moved from the other information apparatus with the idle state.

6. The information processing method according to claim 4, the method further comprising:
when receiving the process execution request, identifying a simplified virtual machine corresponding to the virtual machine to which the process execution request has been issued, on the basis of a correspondence between the virtual machine and a simplified virtual machine that emulates only the idle state of the virtual machine; and
moving the identified simplified virtual machine to the other information apparatus.

7. The information processing method according to claim 6, the method further comprising:
instructing the other information apparatus to add a function desirable in executing the process.

8. The information processing method according to claim 4,
wherein the other information apparatus includes a plurality of computation units, and
wherein the information processing method further comprising:
controlling to stop a supply of power to a computation unit that is not running the virtual machine.
